(19) United States
(12) Patent Application Publication
(10) Pub. No.: US 2012/0120656 A1
(43) Pub. Date: May 17, 2012

(54) LIGHTING DEVICE AND DISPLAY DEVICE

(75) Inventors: Yuhsaku Ajichi, Osaka (JP); Takeshi Masuda, Osaka (JP); Akira Tomiyoshi, Osaka (JP); Naoto Inoue, Osaka (JP)

(73) Assignee: SHARP KABUSHIKI KAISHA, Osaka-shi, Osaka (JP)

(21) Appl. No.: 13/386,555

(22) PCT Filed: May 12, 2010
(86) PCT No.: PCT/JP2010/058039

§ 371 Date: Jan. 23, 2012

(30) Foreign Application Priority Data
Oct. 19, 2009 (JP) 2009-240658

(51) Int. Cl. F21V 7/00

(52) U.S. Cl. 362/235

(57) ABSTRACT

An illumination device (10) comprises: a plurality of substrates (3) each of which has one surface on which a plurality of light sources (5) are provided; a plurality of first reflecting sheets (7), which cover the one surfaces of the respective plurality of substrates (3) so as to leave the plurality of light sources (5) uncovered; a supporting plate (1) which supports the plurality of substrates (3); and a second reflecting sheet (8) which covers an upper surface of the supporting plate (1) in a gap between respective adjacent ones of the plurality of substrate (3). This makes it possible to provide an illumination device capable of irradiating light without luminance non-uniformity.

### TECHNICAL FIELD

The present invention relates to an illumination device having a plurality of light sources and a display device including the illumination device.

### BACKGROUND ART

In recent years, a liquid crystal display device, which has been rapidly expanding its use in place of a cathode-ray tube (CRT), are widely used in a liquid crystal TV, a monitor, a mobile phone, and the like in which features of the liquid crystal display device, namely, being energy-saving, thin, and lightweight, are well utilized. For such a liquid crystal display device, improvement of an illumination device (known as a backlight), which is provided behind the liquid crystal display device, can be exemplified as a way to better utilize the features.

The backlight, which is an illumination device, can be roughly classified into a side light backlight (also called an edge light backlight) or a direct backlight. The side light backlight has a configuration in which (i) a light guide plate is provided behind a liquid crystal display panel and (ii) a light source is provided at an edge of the light guide plate. Light emitted from the light source is reflected by the light guide plate and indirectly and uniformly irradiated toward the liquid crystal display panel. The configuration makes it possible to provide an illumination device which has low luminance but is thin. As such, a side light illumination device is employed principally in a small or medium liquid crystal display in such as a mobile phone and a notebook PC.

In a direct illumination device, a plurality of light sources are arranged behind a liquid crystal display panel, so that light is directly irradiated toward the liquid crystal display panel. This allows the direct illumination device to attain high luminance even in a large screen. As such, the direct illumination device is employed principally in a large, 20-inch or wider liquid crystal display. Examples of a light source used in the direct illumination device encompass a cold cathode fluorescent lamp (CCFL) and a light-emitting diode (LED). In a direct illumination device which uses CCFLs as light sources, a reflecting sheet is provided over an entire inner-back surface, which inner-back wall is opposite to a direction toward which light is irradiated, so that light can be used more efficiently.

In comparison, the LED can attain lower power consumption, a longer lifespan, higher luminance, better color reproducibility, and the like than the CCFL. As such, the LED can be advantageously employed as a light source in the direct illumination device. In general, a direct illumination device that uses LEDs as light sources has a configuration in which a substrate on which the LEDs are mounted is provided on a backmost surface inside the direct illumination device. As such, the reflecting sheet for enhancing light utilization efficiency is provided on a surface of the substrate, on which surface the LEDs are provided. A plurality of openings are provided in the reflecting sheet, and the LEDs are inserted into the plurality of openings when the reflecting sheet is provided on the substrate. This prevents the reflecting sheet from blocking light irradiated from the LEDs.

The following description will discuss, with reference to FIGS. 4(a) and 4(b), an example of how to attach the reflecting sheet to the substrate on which the LEDs are mounted. FIG. 4(a) is a view illustrating an example of the substrate on which the LEDs are mounted, and the reflecting sheet. FIG. 4(b) is a view illustrating an example of how to fix the reflecting sheet to the substrate.

As illustrated in FIG. 4(a), a plurality of LEDs 50 are provided on a substrate 30 at even intervals. A plurality of openings are provided in the reflecting sheet 70. Each of the plurality of openings (i) has a larger area than that of each of the plurality of LEDs 50 when viewed from above and (ii) is provided at a place facing the LED 50. As such, in a state where the reflecting sheet 70 is attached to the substrate 30, the plurality of LEDs 50 stick out of the reflecting sheet 70. This allows light emitted from the plurality of LEDs 50 to be efficiently irradiated by the reflecting sheet 70 toward a front of the illumination device, while preventing the substrate 30 from absorbing most of the light.

In general, the reflecting sheet 70 is fixed from the front by use of a dedicated part such as a fixing pin 41 as illustrated in FIG. 4(b). The reflecting sheet 70 is fixed by use of a supporting pin 40, in addition to the fixing pin 41, for supporting a diffusing plate provided at the front of the reflecting sheet 70. The reflecting sheet 70 is fixed generally at 5 to 10 places, though the number of the places depends on a size of the illumination device. The parts for fixing the reflecting sheet 70 are generally arranged with a distance of about 50 to 100 mm between each adjacent ones of the fixing pins 41 or each adjacent ones of the supporting pins 40.

Patent Literature 1 discloses a technique for further improving efficiency in utilizing light irradiated from the LEDs in the direct illumination device. The following description will discuss a configuration of a backlight unit of Patent Literature 1 with reference to FIG. 5.

As illustrated in FIG. 5, a backlight unit 110 of Patent Literature 1 includes (i) a plurality of insulating reflecting sheets 140 each of which is provided for each of a plurality of LED light sources 160 and has, at a center of the insulating reflecting sheet 140, a first window section 140a for arranging the LED light source 160 and (ii) a reflecting sheet 150 which has a plurality of second window sections 150a for arranging the respective plurality of window sections 160. The reflecting sheet 150 is provided on the plurality of insulating reflecting sheets 140. Each of the first window sections 140a has a diameter smaller than that of each of the second window sections 150a. Each of the plurality of insulating reflecting sheets 140 is exposed in each of the second window section 150a.

According to the configuration of the backlight unit of Patent Literature 1, even in a case where light horizontally emitted from the plurality of LED light sources 160 is reflected by edges of the reflecting sheet 150, the light is reflected by the plurality of insulating reflecting sheets 140 located below the reflecting sheet 150. This prevents light emitted to front from being absorbed by a substrate 300. That is, the backlight unit of Patent Literature 1 can attain improvement in light utilization efficiency and reduction in power consumption.

### CITATION LIST

### [Patent Literature]

Patent Literature 1
Japanese Patent Application Publication, Tokukai, No. 2009-37946 A (Publication Date: Feb. 19, 2009)

### SUMMARY OF INVENTION

### Technical Problem

However, (i) the configuration of the reflecting sheet 70 and the example of how to attach the reflecting sheet 70 illustrated in FIG. 4(a) and FIG. 4(b) and (ii) the backlight unit described in Patent Literature 1 have a problem in which the reflecting sheet is apt to have big warpage or flexure at an edge of the reflecting sheet due to being provided as a single sheet. The following description will discuss the problem.

Initially, in the configuration of the reflecting sheet 70 and the example of how to attach the reflecting sheet 70 illustrated in FIG. 4(a) and FIG. 4(b), heat generated by the plurality of LEDs 50 when the plurality of LEDs 50 emit light causes the reflecting sheet 70 to expand. This causes edges of the plurality of openings, each of which is provided for each of the plurality of LEDs 50, to be warped. The following description will discuss this with reference to FIG. 6. FIG. 6 is a cross-sectional view illustrating how a state in which the reflecting sheet is provided changes in response to irradiation of light in the conventional illumination device. (a) of FIG. 6 illustrates the reflecting sheet 70 before expanding with heat. (b) of FIG. 6 illustrates the reflecting sheet 70 which has expanded with heat to have a warpage (flexure).

As illustrated in (a) of FIG. 6, the reflecting sheet 70 is tightly attached to the substrate 30 before the plurality of LEDs 50 irradiate light. However, when the illumination device is used, the reflecting sheet 70 expands with heat that is emitted from the plurality of LEDs 50 and received by the reflecting sheet 70. This causes an edge of each of the plurality of openings to be warped away from the substrate 30 as illustrated in (b) of FIG. 6. The plurality of LEDs 50 are partially hidden behind the warped edges when viewed from the front, so that light which is (i) part of light irradiated from the plurality of LEDs 50 and (ii) irradiated in an oblique direction is partially blocked. This causes non-uniformity in intensity of light emitted to the front. As a result, light irradiated from the illumination device to an object has non-uniform luminance.

The reflecting sheet 70, which is a single sheet, needs to be large in accordance with an area of the substrate 50 so as to completely cover a front surface of the substrate 50. Since heat expansion rate of the reflecting sheet 70 increases in proportion to the area of the reflecting sheet 70, the warpage at the edges occurs to a greater extent in a case where the reflecting sheet 70 is provided as a single sheet.

Next, in a case where the plurality of insulating reflecting sheets 140 and the reflecting sheet 150 are provided without being fixed in the backlight unit described in Patent Literature 1, heat generated by irradiation of light from the LEDs causes the plurality of insulating reflecting sheets 140 and the reflecting sheet 150, which are unfixed, to (i) expand in accordance with their respective thermal expansion coefficients and (ii) accordingly have a warpage (flexure) toward the front. Since the reflecting sheet 150 is provided as a single sheet, the reflecting sheet 150 has particularly great warpage, as early described. The warpage causes luminance non-uniformity of reflected light and/or inhibits irradiation of light from the plurality of LED light sources 160 to the front.

In comparison, in a case where the plurality of insulating reflecting sheets 140 and the reflecting sheet 150 are provided in such a manner that the plurality of insulating reflecting sheets 140 and the reflecting sheet 150 are fixed by means of the fixing pins 41, the supporting pins 40, or the like, the warpage becomes more prominent. This is because the plurality of insulating reflecting sheets 140 are made of a different material from that of the reflecting sheet 150 and accordingly have a different thermal expansion coefficient from that of the reflecting sheet 150. That is, although the warpage (or flexure) is prevented at places where the plurality of insulating reflecting sheets 140 and the reflecting sheet 150 are fixed, the plurality of insulating reflecting sheets 140 exert a force to the reflecting sheet 150, and vice versa, at places where the plurality of insulating reflecting sheets 140 are in contact with the reflecting sheet 150. As a result, the warpage toward the front occurs more prominently at the places where the plurality of insulating reflecting sheets 140 are in contact with the reflecting sheet 150 (for example, in the vicinities of the openings of the reflecting sheet 150).

The present invention is accomplished in view of the aforementioned problem. An object of the present invention is to provide an illumination device which is capable of irradiating uniform light without luminance non-uniformity.

### Solution to Problem

In order to attain the object, the illumination device of the present invention is an illumination device including: a plurality of substrates each of which has one surface on which a plurality of light sources are provided; a plurality of first reflecting sheets, which cover the one surfaces of the respective plurality of substrates so as to leave the plurality of light sources uncovered; a supporting plate which supports the plurality of substrates; and a second reflecting sheet which covers an upper surface of the supporting plate in a gap between respective adjacent ones of the plurality of substrate.

According to the configuration, the presence of the plurality of substrates on which the plurality of light sources are provided allows a reflecting sheet with a smaller area to be employed as each of the plurality of first reflecting sheets covering the respective plurality of substrates, as compared with a case in which a single substrate on which many light sources are provided is covered. The smaller area the reflecting sheet has, the less the reflecting sheet expands with heat generated from the light source at a time of light irradiation. In a case where the extent to which the reflecting sheet expands is reduced, warpage (flexure) of the reflecting sheet can be suppressed easily. This prevents the reflecting sheet from being warped to block part of light emitted from the light source when the illumination device is used.

In the case where the illumination device is constituted by the plurality of substrates and the plurality of first reflecting sheets which are separately provided for each of the plurality of substrates, gaps will inevitably be formed between adjacent ones of the plurality of substrates. The gaps becomes a new cause of luminance non-uniformity.

In view of this, the present invention employs a configuration in which the supporting plate for supporting the plurality of substrates is utilized so as to provide the second reflecting sheet, which covers the upper surface of the supporting plate, on the supporting plate in the gap between respective adjacent ones of the plurality of substrates. This allows prevention of luminance non-uniformity caused by the gap.

That is, according to the configuration, use of the plurality of first reflecting sheets as well as the second reflecting sheet makes it possible to irradiate an object with light without luminance non-uniformity.

Note that the second reflecting sheet is not limited to a specific one, provided that the second reflecting sheet covers a supporting surface of the supporting plate at least at a part corresponding to the gap. The second reflecting sheet can therefore be a single sheet or a plurality of sheets. In a case where a single sheet is employed as the second reflecting sheet, it can be (i) a sheet covering the entire supporting surface of the supporting plate or (ii) a sheet having a plurality of openings which are provided so that the plurality of substrates are located in the respective plurality of openings. A second reflecting sheet provided as a plurality of sheets can be a plurality of sheets each of which are provided so as to appropriately cover portions corresponding to the gaps.

Note that the plurality of reflecting sheets have the same shape or different shapes. A single second reflecting sheet having the plurality of openings can be partially sandwiched between the plurality of substrates and the supporting plate. The same applies to a plurality of second reflecting sheets. An extent to which the second reflecting sheet(s) is (are) sandwiched between the plurality of substrates and the supporting plate does not affect the essence of the present invention and can therefore be appropriately modified.

In order to attain the object, a display device of the present invention is a display device including: the illumination device and a display panel.

The configuration can bring about the same effect as that attained by the illumination device.

### Advantageous Effects of Invention

With these configurations, the illumination device of the present invention includes: the plurality of substrates each of which has one surface on which the plurality of light sources are provided; the plurality of first reflecting sheets, which cover the one surfaces of the respective plurality of substrates so as to leave the plurality of light sources uncovered; the supporting plate which supports the plurality of substrates; and the second reflecting sheet which covers the upper surface of the supporting plate in the gap between respective adjacent ones of the plurality of substrate. With this configuration, it becomes possible to irradiate light without luminance non-uniformity.

### BRIEF DESCRIPTION OF DRAWINGS

FIG. 1 is a cross-sectional view illustrating a configuration of an illumination device in accordance with an embodiment of the present invention.

FIG. 2 is a cross-sectional view illustrating a configuration of the illumination device in accordance with the embodiment of the present invention, which configuration is different from that illustrated in FIG. 1.

FIG. 3 is a cross-sectional view illustrating a configuration of the illumination device in accordance with the embodiment of the present invention, which configuration is different from that illustrated in FIGS. 1 and 2.

FIG. 4a is a perspective view illustrating a conventional illumination device.

FIG. 4b is a cross-sectional view illustrating an example of how to attach a reflecting sheet to a substrate in the conventional illumination device.

FIG. 5 is a cross-sectional view illustrating a configuration of another conventional illumination device.

FIG. 6 is a cross-sectional view illustrating a state in which a reflecting sheet in a conventional illumination device is arranged, which state changes in response to irradiation of light. (a) of FIG. 6 illustrates a state before the irradiation of light. (b) of FIG. 6 illustrates a state before or during the irradiation of light.

### DESCRIPTION OF EMBODIMENTS

The following exemplifies embodiments of the present invention in detail, with reference to the drawings. Note that size, material, shape, and the way of arrangement of each member described in the present embodiments and illustrated in the drawings are merely examples for exemplifying the present invention, and therefore the spirit and scope of the invention should not be limited by these embodiments.

### Embodiment 1

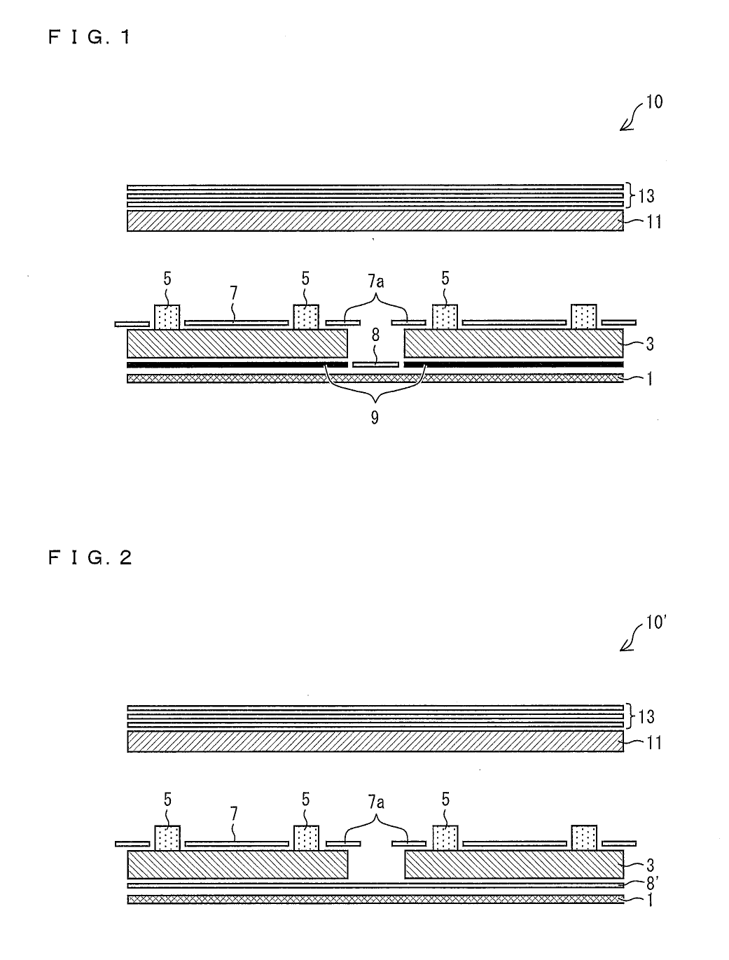

The following description will discuss, with reference to FIG. 1, an illumination device 10 in accordance with an embodiment of the present invention. FIG. 1 is a cross-sectional view illustrating a configuration of the illumination device 10 in accordance with the embodiment of the present invention.

(Illumination Device 10)

As illustrated in FIG. 1, the illumination device 10 includes a backlight chassis (supporting plate) 1, a plurality of LED substrates (substrates) 3, a plurality of LEDs (light sources) 5 provided on one face of each of the plurality of LED substrates 3, a plurality of first reflecting sheets 7 which cover surfaces of the respective plurality of LED substrates 3, on each of which surfaces the plurality of LEDs 5 are provided, a plurality of insulating sheets 9 each provided between the respective plurality of LED substrates 3 and the backlight chassis 1, a second reflecting sheet 8 provided on regions of the backlight chassis 1 each of which regions is not covered by any of the plurality of LED substrates 3, a diffusing plate 11 provided to face the plurality of LED substrates 3, and an optical sheet 13 provided above the diffusing plate 11. That is, the illumination device 10 in accordance with the present embodiment is a direct backlight unit in which a liquid crystal display panel is irradiated with light emitted from the plurality of LEDs 5, via the diffusing plate 11 and the optical sheet 13.

The following description will discuss details and functions of constituents in the illumination device 10 in accordance with the present embodiment.

(Led Substrate 3 and LED 5)

The plurality of LED substrates 3 are substrates each of which has a main surface (surface on which the plurality of LEDs 5 are to be provided) on which the plurality of LEDs 5 are provided at even intervals. As illustrated in FIG. 1, the plurality of LED substrates 3 are provided on a back surface side (on the backlight chassis 1 side) of the illumination device 10. As such, each of the plurality of LED substrates 3 has a main surface with a far smaller area than that of a configuration in which all of the plurality of LEDs 5 to be used in the illumination device 10 are provided on a single LED substrate 3. That is, since (i) all of the plurality of LEDs 5 to be used in the illumination device 10 are divided into a plurality of groups each made up of an equal number of LEDs 5 and (ii) each of the plurality of groups is provided on corresponding one of the plurality of LED substrates 3, an area of a main surface of each of the plurality of LED substrates 3 is reduced approximately in inverse proportion to the number of the plurality of LED substrates 3.

Examples of the plurality of LED substrates 3 encompass a conventionally known printed circuit board which is made of a material such as a glass epoxy material and on a main surface of which a wiring pattern is provided.

Each of the plurality of LEDs 5 is a conventionally known LED that emits white light. Examples of the LED that emits white light encompasses (i) an LED which is obtained by (a) placing, on a blue LED chip, a resin in which yellow-emitting phosphor is mixed and (b) sealing the blue LED chip with the resin, (ii) an LED which is obtained by combining a blue LED chip, red (R) phosphor, and green (G) phosphor, (iii) an LED which is obtained by combining an ultraviolet LED, red (R) phosphor, green (G) phosphor, and blue (G) phosphor, and (iv) a combination of a red (R) LED chip, a green (G) LED chip, and a blue (G) LED chip.

(First Reflecting Sheet 7)

Each of the plurality of first reflecting sheets 7 is a sheet member for reflecting and diffusing, toward a front of the irradiation device 10 (to above the diffusing plate 11 and the optical sheet 13), light irradiated from the plurality of LEDs 5. As illustrated in FIG. 1, the plurality of first reflecting sheets 7, which cover the main surfaces of the respective plurality of LED substrates 3, each have a plurality of openings which are arranged at even intervals. The plurality of openings, in each of the plurality of first reflecting sheets 7, are provided so as to face the plurality of LEDs 5 on the respective plurality of LED substrates 3. Each of the plurality of openings has (i) a shape substantially matching that of corresponding one of the plurality of LEDs 5 when viewed from the front and (ii) an area larger than that of the corresponding one of the plurality of LEDs 5 when viewed from the front. As such, in a state where the plurality of first reflecting sheets 7 covering the main surfaces of the respective plurality of LED substrates 3 are provided on the respective plurality of LED substrates 3, the plurality of LEDs 5 project from the respective plurality of openings. This prevents the plurality of first reflecting sheets 7 from blocking light emitted from the plurality of LEDs 5.

As illustrated in FIG. 1, the plurality of first reflecting sheets 7 are provided in accordance with areas of the respective plurality of LED substrates 3, instead of being provided as a single sheet. As such, it is possible to reduce an area of each of the plurality of first reflecting sheets 7 in inverse proportion to the number of the plurality of first reflecting sheets 7, like the area of each of the plurality of LED substrates 3 is reduced in inverse proportion to the number of the plurality of LED substrates 3.

The plurality of first reflecting sheets 7 are white sheets generally used. Examples of a material of the plurality of first reflecting sheets 7 encompass resin materials such as PET (polyethylene terephthalate), PC (polycarbonate), and PS (polystyrene). The plurality of first reflecting sheets 7 are fixed to the respective plurality of LED substrates 3 by means of a conventionally known heat-insulating double-faced adhesive tape or the like.

(Second Reflecting Sheet 8)

As illustrated in FIG. 1, each of the reflecting sheets 7 is provided in a part which (i) is on a surface of the backlight chassis 1, to which surface the plurality of LED substrates 3 are attached, and (ii) corresponds to a gap between respective adjacent ones of the plurality of LED substrates 3.

That is, the illumination device 10 in accordance with the present embodiment includes (i) the plurality of LED substrates 3, on the main surface (one face) of each of which the plurality of LEDs 5 are provided, (ii) the plurality of reflecting sheets 7, which cover the main surfaces (surfaces on each of which the plurality of LEDs are provided) of the respective plurality of LED substrates 3 so as to leave the respective plurality of LEDs 5 uncovered, (iii) the backlight chassis 1 which supports the plurality of LED substrates 3, and (iv) the second reflecting sheet 8 which covers an upper surface of the backlight chassis 1, in a gap formed between respective adjacent ones of the plurality of LED substrates 3.

Note that, as illustrated in FIG. 1, the plurality of first reflecting sheets 7, which cover the main surfaces of the respective plurality of LED substrates 3, have areas slightly larger than the main surfaces of the respective plurality of LED substrates 3. As early described, an area of a main surface of each of the plurality of LED substrates 3 is far smaller than that corresponding to a configuration in which only a single LED substrate 3 is used. That is, each of the plurality of first reflecting sheets 7 covering the main surfaces of the plurality of LED substrates 3 can be configured to have a far smaller area. As such, heat generated when the plurality of LEDs 5 emit light causes corresponding one of the plurality of first reflecting sheets 7, which covers corresponding one of the plurality of LED substrates 3, to expand only to a very small extent. This is because each of the plurality of first reflecting sheets 7 has a small area. As a result, the corresponding one of the plurality of first reflecting sheets 7 hardly becomes warped toward the front of the irradiation device 10 when the plurality of LEDs 5 emit light.

In addition, the second reflecting sheet 8 is provided in a gap, on the upper surface of the backlight chassis 1, between respective adjacent ones of the plurality of LED substrates 3. This makes it possible to reflect, toward the front, part of light which enters a part sandwiched between the respective adjacent ones of the plurality of LED substrates 3.

Thus, light emitted from the plurality of LEDs 5 is never blocked by the plurality of reflecting sheets 7 when the plurality of LEDs 5 emit the light. This allows the illumination device 10 in accordance with the present embodiment to irradiate light which is uniformly diffused toward the front and has no luminance non-uniformity.

As described above, the plurality of reflecting sheets 7, which cover the main surfaces of the respective plurality of LED substrates 3, have areas larger than the main surfaces of the respective plurality of LED substrates 3. In other words, according to the illumination device 10 of the present embodiment, edges 7a (see FIG. 1) of each of the plurality of reflecting sheets 7, which cover the respective plurality of LED substrates 3, project from a main surface of corresponding one of the respective plurality of LED substrates 3.

This configuration allows the main surfaces of the plurality of LED substrates 3 to be reliably covered by the respective plurality of reflecting sheets 7, even in a case where the plurality of reflecting sheet 7 are attached to the respective plurality of LED substrates 3 with some misalignment. In addition, the edges 7a of each of the plurality of reflecting sheets 7 project toward parts of the respective regions outside a main surface of corresponding one of the LED substrate 3 (i.e., regions in the gap sandwiched between corresponding adjacent ones of the plurality of LED substrates 3). As such, it is possible to reflect, toward the front, part of light which would otherwise enter and be absorbed by side surfaces of the corresponding one of plurality of LED substrates 3. Therefore, this makes it possible to (i) facilitate assembly of the illumination device 10 and (ii) cause an object to be irradiated to be more uniformly irradiated with light emitted from the illumination device 10.

It is possible to employ, as the second reflecting sheet 8, either a single reflecting sheet or a plurality of reflecting sheets. In a case where a single reflecting sheet is employed as the second reflecting sheet 8, it can be, for example, a reflecting sheet having a plurality of openings which are provided so that the plurality of LED substrates 3 are located in the respective plurality of openings. The plurality of insulating sheets 9 (later described) are provided in the respective plurality of openings. In a case where a plurality of reflecting sheets are employed as the second reflecting sheet 8, they are, for example, provided so as not to cover the regions where the respective plurality of LED substrates 3 are provided. The plurality of reflecting sheets have an identical shape or different shapes.

The second reflecting sheet 8 is a generally used white sheet and is made of the same material as that of the plurality of first reflecting sheets 7. The second reflecting sheet 8 is fixed to the plurality of LED substrates 3 and the backlight chassis 1 in a manner similar to the plurality of first reflecting sheets 7.

In the present embodiment, the illumination device 10 insulates the plurality of LED substrates 3 from the backlight chassis 1, as described later. However, in a case where the backlight chassis 1 is made of an insulating material, it becomes unnecessary to insulate the plurality of LED substrates 3 from the backlight chassis 1. In such a case, it is possible to make smaller the plurality of openings, in the single reflecting sheet which is employed as the second reflecting sheet 8, than the regions where the respective plurality of LED substrates 3 are provided. In a case where the plurality of reflecting sheets are employed as the second reflecting sheet 8, they can be partially sandwiched between the backlight chassis 1 and the plurality of LED substrates 3. In a case where the second reflecting sheet 8 is made of an insulating material, the single reflecting sheet or the plurality of reflecting sheets, employed as the second reflecting sheet 8, can be partially sandwiched between the backlight chassis 1 and the plurality of LED substrates 3.

(Insulating Sheet 9)

As illustrated in FIG. 1, the plurality of insulating sheets 9 are provided between the plurality of LED substrates 3 and the backlight chassis 1. This allows insulation to be ensured between the plurality of LED substrates 3 and the backlight chassis 1. It is possible to prevent the illumination device 10 from being short-circuited, for example, when the backlight chassis 1 made of metal is brought into contact with a through hole and/or an electrically conductive part, which are on the back surface (a surface facing the backlight chassis 1) of the plurality of LED substrates 3. This makes it possible to freely select a material of the backlight chassis 1 and a configuration of the plurality of LED substrates 3 without a concern for the short-circuit in the illumination device 10.

The insulating sheet 9 is not limited to a specific one, provided that it is capable of insulating the plurality of LED substrates 3 from the backlight chassis 1. Examples of the insulating sheet 9 encompass (i) a sheet made of a conventionally known insulating material and (ii) sheets which are made of various materials and surfaces of which are covered with an insulating material.

The present embodiment employs a configuration in which the second reflecting sheet 8 and the plurality of insulating sheets 9 are separately attached. Note, however, that it is preferable that the second reflecting sheet 8 and the plurality of insulating sheets 9, provided on the backlight chassis 1, are realized by a single insulating sheet (8, 9) which is partially reflective, i.e., which has a part, having reflectivity, which is sandwiched between respective adjacent ones of the plurality of LED substrates 3.

According to the configuration, simply by attaching a single sheet to the backlight chassis 1, it is possible to (i) provide the plurality of insulating sheets 9 in the regions where the respective plurality of LED substrates 3 are attached and (ii) provide the reflecting sheet 7 so that the reflecting sheet 7 is sandwiched between the respective plurality of LED substrates 3. It also becomes possible to reduce the number of components for assembling the illumination device 10. That is, the assembly of the illumination device 10 can be facilitated.

Examples of the single insulating sheet (8, 9), which is partially reflective, encompass (i) a sheet obtained by coating a desired region of a single insulating sheet 9 with the white material of which the second reflecting sheet 8 is made and (ii) a sheet obtained by attaching the second reflecting sheet 8 to the desired region.

(Diffusing Plate 11 and Optical Sheet 13)

The diffusing plate 11 and the optical sheet 13 are employed for obtaining uniform in-plane light intensity by diffusing incident light and mixing colors of the incident light. That is, light emitted from the plurality of LEDs 5 are caused to transmit through the diffusing plate 11 and the optical sheet 13, so that luminance and chromaticity uniform are improved. As illustrated in FIG. 1, the diffusing plate 11 and the optical sheet 13 are provided with respective certain distances from the plurality of LEDs 5.

The diffusing plate 11 is not limited to a specific one, provided that it has a shape of a plate made of a material such as acrylic resin or polycarbonate resin. The optical sheet 13 is a sheet obtained by dispersing silica particles or the like in a resin such as acrylic resin or polycarbonate resin.

The description above exemplifies the optical sheet 13 as one whose single purpose is to disperse the incident light and mixing colors of the incident light. However, the optical sheet 13 can be configured by a plurality of sheets as illustrated in FIG. 1, and therefore it is possible to configure the optical sheet 13 by appropriately combining a sheet having properties as described above with a sheet having a property that can improve luminance and uniformity of light emitted toward the front.

Thus, the illumination device 10 in accordance with the embodiment of the present invention brings about effects as described above. Therefore, by employing the illumination device 10 as a backlight of a liquid crystal display device in combination with various liquid crystal display panels, it is possible to provide a liquid crystal display device capable of attaining uniform display without luminance non-uniformity.

### Embodiment 2

The following description will describe an illumination device 10′ in accordance with an embodiment of the present invention, with reference to FIG. 2. FIG. 2 is a cross-sectional view illustrating a configuration of the illumination device 10′ in accordance with the embodiment of the present invention.

As illustrated in FIG. 2, the illumination device 10′ includes a backlight chassis 1, a plurality of LED substrates 3, a plurality of LEDs 5 provided on one face of each of the plurality of LED substrates 3, a plurality of reflecting sheets 7 which cover surfaces of the respective plurality of LED substrates 3, on each of which surfaces the plurality of LEDs 5 are provided, an insulating reflecting sheet 8′ provided between the plurality of LED substrates 3 and the backlight chassis 1, a diffusing plate 11 provided to face the plurality of LED substrates 3, and an optical sheet 13 provided above the diffusing plate 11. That is, the illumination device 10′ is different from the illumination device 10, which includes the plurality of insulating sheets 9 and the plurality of reflecting sheets 7 on the backlight chassis 1, in that the illumination device 10′ includes the insulating reflecting sheet 8′ on the backlight chassis 1. The description of the present embodiment will therefore only discuss details of the insulating reflecting sheet 8′.

As illustrated in FIG. 2, the insulating reflecting sheet 8′ is a single sheet provided between the backlight chassis 1 and the plurality of LED substrates 3. Since the insulating reflecting sheet 8′ serves as a single sheet having an insulation property, no positioning of the plurality of LED substrates 3 is necessary. In addition, since the insulating reflecting sheet 8′ serves also as a single reflecting sheet, no positioning of the reflecting sheet with respect to the area sandwiched between the plurality of LED substrates is also necessary. Further, since only a single sheet is required to configure the insulating reflecting sheet 8′, the number of components can be reduced. Therefore, the illumination device 10′ can be assembled very easily.

Note that the insulating reflecting sheet 8′ is not limited to a specific one, provided that it is a sheet having an insulation property and reflecting and diffusing light on a surface of the sheet. Such being the case, the insulating reflecting sheet 8′ is a generally used white sheet made of a material such as the material described in the chapter (First reflecting sheet 7) in embodiment 1. Examples of the insulating reflecting sheet 8′ encompass, for example, E6SV, which is manufactured by TORAY Industries, Inc. and made of a material such as PET.

As described above, the illumination device 10′ can (i) irradiate uniform light without luminance non-uniformity and (ii) be assembled easily.

### Embodiment 3

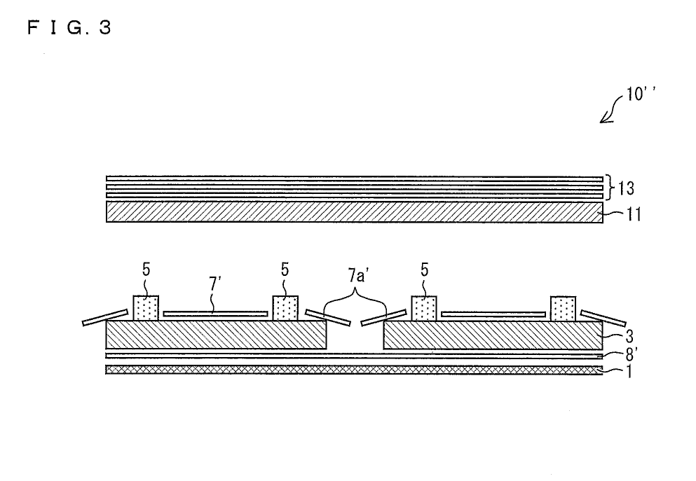

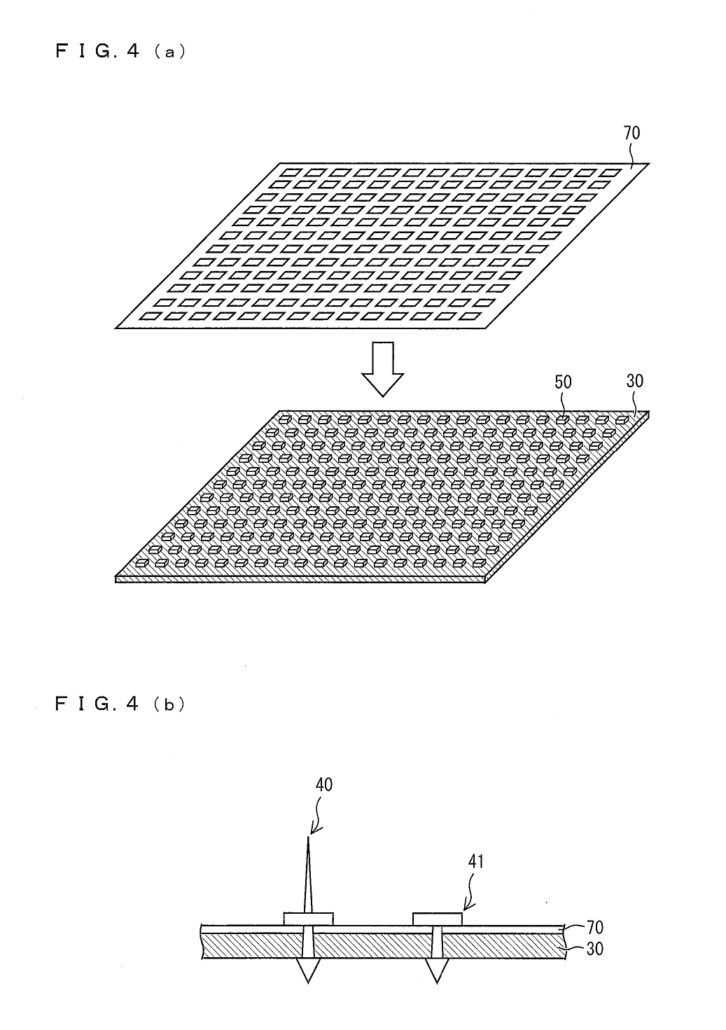

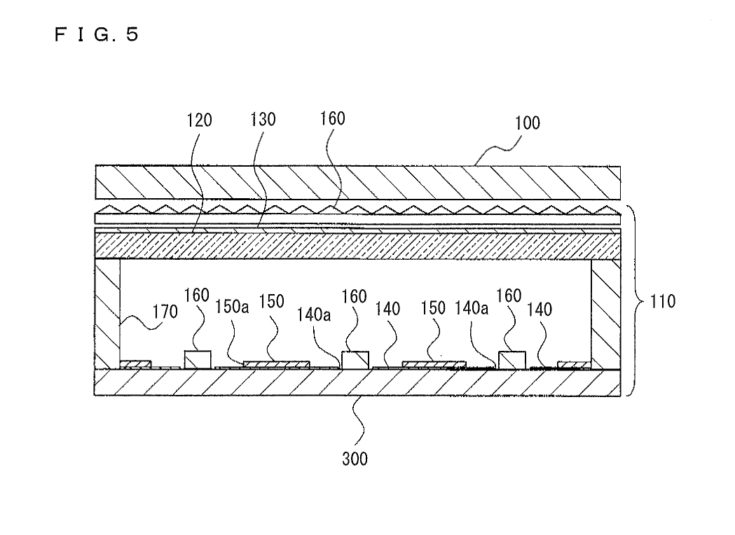

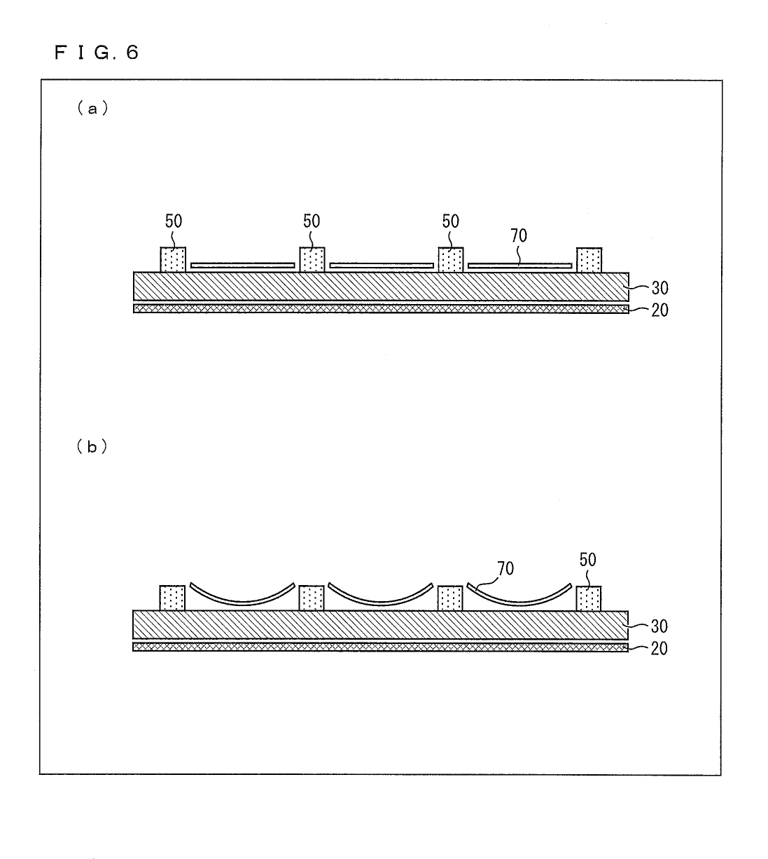

The following description will discuss the illumination device 10″ in accordance with an embodiment of the present invention with reference to FIG. 3. FIG. 3 is a cross-sectional view illustrating a configuration of the illumination device 10″ in accordance with the embodiment of the present invention.

As illustrated in FIG. 3, the illumination device 10″ includes a backlight chassis 1, a plurality of LED substrates 3, a plurality of LEDs 5 provided on one face of each of the plurality of LED substrates 3, a plurality of first reflecting sheets 7′ which cover surfaces of the respective plurality of LED substrates 3, on each of which surfaces the plurality of LEDs 5 are provided, an insulating reflecting sheet 8′ provided between the plurality of LED substrates 3 and the backlight chassis 1, a diffusing plate 11 provided to face the plurality of LED substrates 3, and an optical sheet 13 provided above the diffusing plate 11. That is, the illumination device 10″ is different from the illumination device 10 and the illumination device 10′, both of which include the plurality of reflecting sheets 7 which cover the respective plurality of LED substrates 3, in that the illumination device 10″ includes the plurality of first reflecting sheets 7′ which cover the respective plurality of LED substrates 3. The description of the present embodiment will therefore only discuss details of the plurality of first reflecting sheets 7′.

(First Reflecting Sheet 7′)

As illustrated in FIG. 3, the plurality of first reflecting sheets 7′ covers the main surfaces of the respective plurality of LED substrates 3. Each of the plurality of first reflecting sheets 7′ is provided such that a plurality of LEDs 5 project from respective openings provided in the each of the plurality of first reflecting sheets 7′. Each of the plurality of first reflecting sheets 7′ has an area larger than that of each of plurality of reflecting sheets 7 described in Embodiments 1 and 2. The illumination device 10″ is, when viewed from the front, covered by the plurality of first reflecting sheets 7′ except regions where the plurality of LEDs 5 are provided. As such, adjacent edges 7a′ of the plurality of first reflecting sheets 7′ cover almost entirety of an area sandwiched between the respective plurality of LED substrates 3. This allows most of light to be reflected toward the front. As a result, light barely enters the area sandwiched between the respective plurality of LED substrates 3. The illumination device 10″ in accordance with the present embodiment can thus irradiate, toward the front, light which is diffused more uniformly and has no luminance non-uniformity.

As illustrated in FIG. 3, the edges 7a′ of each of the plurality of first reflecting sheets 7′ are provided outwards so as to be slightly tilted downward (toward the backlight chassis 1). This allows the side surfaces of each of the plurality of LED substrates 3 to be more reliably covered by corresponding one of the plurality of first reflecting sheets 7′.

The present embodiment employs a configuration in which some space is secured between the respective adjacent edges 7a′. Note, however, that the present embodiment can employ, for example, a configuration in which adjacent edges 7a′ of a plurality of first reflecting sheets 7′ are in contact with each other or overlap each other. In the configuration, light does not enter side surfaces of a plurality of LED substrates 3 nor an area sandwiched between the respective plurality of LED substrates 3. This allows a replacement of the insulating reflecting sheet 8′, which is provided between the plurality of LED substrates 3 and the backlight chassis 1, with a single insulating sheet 9. Alternatively, the insulating reflecting sheet 8′ can be replaced with a plurality of insulating sheets 9 provided under the plurality of LED substrates 3.

[Preferred Configuration and Effect Thereof]

It is preferable that the illumination device of the present invention further include a plurality of insulating sheets provided between the plurality of substrates and the supporting plate.

With the configuration, it becomes possible to ensure an insulation property between the plurality of substrates and the supporting section in a case where the supporting plate is made of a material which requires insulation of the plurality of substrates from the supporting plate.

It is preferable that the second reflecting sheet be a single insulating reflecting sheet sandwiched between the plurality of substrates and the supporting plate in the illumination device of the present invention.

With the configuration, it becomes possible to eliminate the need for attaching both of the reflecting sheet and the plurality of insulating sheets to the supporting section in the case where the supporting plate is made of a material that requires insulation of the plurality of substrates from the supporting plate. It accordingly becomes possible to reduce the number of components. Since the second reflecting sheet is sufficiently fixed by being sandwiched between the plurality of substrates and the supporting plate, warpage and/or flexure caused by heat is less apt to occur. Therefore, it becomes possible to provide an illumination device which can be easily assembled and whose uniform irradiation property hardly changes over time.

It is preferable that the second reflecting sheet be a single insulating sheet which (i) covers between the plurality of substrates and the supporting plate and (ii) has a part with reflectivity on the supporting plate, the part corresponding to the gap in the illumination device of the present invention.

With the configuration, it becomes possible to eliminate the need of attaching both of the second reflecting sheet and the plurality of insulating sheets to the supporting section. This can reduce the number of components. Since the second reflecting sheet is sufficiently fixed by being sandwiched between the plurality of substrates and the supporting plate, warpage and/or flexure caused by heat is less apt to occur. Therefore, it becomes possible to provide an illumination device which can be easily assembled and whose uniform irradiation property hardly changes over time.

It is preferable that in the illumination device of the present invention, edges of each of the plurality of first reflecting sheets project from the one surface of corresponding one of the plurality of substrates.

With the configuration, it becomes possible to cover the one surfaces of the plurality of substrates, by use of reflecting sheets each of which has a larger area than the one surface of corresponding one of the plurality of substrates. This allows the one surfaces of the plurality of substrates to be reliably covered by the respective reflecting sheets even if the reflecting sheets are attached to the respective plurality of substrates with some misalignment. In addition, the edges of each of the reflecting sheets stick out toward parts of each gap between the plurality of substrates, it is possible to prevent, for example, light from entering and being absorbed by side surfaces of the plurality of substrates. That is, it becomes possible to (i) facilitate assembly of the illumination device and (ii) cause light from the illumination device to be more uniformly irradiated to an object to be irradiated.

It is preferable that the edges of each of the plurality of first reflecting sheets be tilted from the one surface toward the supporting plate in the illumination device of the present invention.

According to the configuration, the side surfaces of each of the plurality of substrates are better covered by the edges of corresponding one of the plurality of first reflecting sheets, which edges project from the one surface of the substrate. This allows light from the illumination device to be more uniformly irradiated toward the object to be irradiated.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to an illumination device employed as a backlight or the like in a display device, and a display device including the illumination device.

### REFERENCE SIGNS LIST

1: backlight chassis
3: LED substrate
5: LED
7: first reflecting sheet
7′: first reflecting sheet
7a: edge
7a′: edge
8: second reflecting sheet
8′: insulating reflecting sheet
9: insulating sheet
10: illumination device
10′: illumination device
10″: illumination device
11: diffusing plate
13: optical sheet

1. An illumination device comprising:
a plurality of substrates each of which has one surface on which a plurality of light sources are provided;
a plurality of first reflecting sheets, which cover the one surfaces of the respective plurality of substrates so as to leave the plurality of light sources uncovered;
a supporting plate which supports the plurality of substrates; and
a second reflecting sheet which covers an upper surface of the supporting plate in a gap between respective adjacent ones of the plurality of substrate.

2. An illumination device as set forth in claim 1, further comprising:
a plurality of insulating sheets provided between the plurality of substrates and the supporting plate.

3. The illumination device as set forth in claim 1, wherein the second reflecting sheet is a single insulating reflecting sheet sandwiched between the plurality of substrates and the supporting plate.

4. The illumination device as set forth in claim 1, wherein the second reflecting sheet is a single insulating sheet which (i) is sandwiched between the plurality of substrates and the supporting plate and (ii) has a part with reflectivity on the supporting plate, the part corresponding to the gap.

5. The illumination device as set forth in claim 1, wherein edges of each of the plurality of first reflecting sheets project from the one surface of corresponding one of the plurality of substrates.

6. The illumination device as set forth in claim 5, wherein the edges of each of the plurality of first reflecting sheets is tilted from the one surface toward the supporting plate.

7. A display device comprising:
an illumination device recited in claim 1; and
a display panel.
